(19) United States
(12) Patent Application Publication
(10) Pub. No.: US 2025/0075027 A1
(43) Pub. Date: Mar. 6, 2025

(54) Polyurethane Foams And Methods Of Manufacture Thereof

(71) Applicant: KINGSPAN HOLDINGS (IRL) LIMITED, Kingscourt (IE)

(72) Inventor: Michael Boyco, Opa-locka, FL (US)

(21) Appl. No.: 18/241,880

(22) Filed: Sep. 3, 2023

(51) Int. Cl. C08G 18/76; C08J 9/14

(52) U.S. Cl. CPC C08G 18/7685; C08J 9/143; C08G 2110/005; C08J 2203/142; C08J 2375/14

(57) ABSTRACT

Foamable polyurethane compositions are provided which comprise a specific polymeric methylene diphenyl diisocyanate (pMDI) component. The foamable polyurethane compositions make polyurethane foams having excellent thermal insulation properties and reaction-to-fire performance. The foamable polyurethane compositions and polyurethane foams are particularly useful for application of thermal insulation in the field. Methods for making and applying the foamable polyurethane compositions and polyurethane foams are also provided.

### FIELD OF THE INVENTION

The present invention relates to thermal insulating foams, in particular polyurethane thermal insulating foams, and compositions and methods for making and applying said thermal insulating foams. The foams of the present invention display excellent reaction-to-fire performance.

### BACKGROUND TO THE INVENTION

Polyurethane (PUR) foams are important industrial products and are used as insulation products in a wide variety of applications, for example in walls, floors, and roofs of buildings, in appliances such as refrigerators and cold storage units, and as insulation for piping.

Polyurethane foams can be produced both in fixed, controlled settings (factories) or be applied in the field (spraying or pouring). Polyurethane foams can be specifically designed to fill open voids or insulate articles outside of a controlled setting.

In-situ application of polyurethane foams is a useful tool when insulating equipment or parts that are already installed, or that are too large or heavy to move. It is also a useful tool for applying insulation to substrates with complex shapes; a user may struggle to find or adapt a pre-formed insulation article that has a good fit around/against the substrate. Of course a poor fit can compromise thermal insulation performance. Similarly, if the substrate is part of a complex assembly, there may not be sufficient access to the substrate to enable a pre-formed insulation article to be attached. In-situ application of a polyurethane foam involves direct application of a foamable polyurethane composition to a substrate.

In-situ application of a polyurethane foam often involves spraying or pouring of a foamable polyurethane composition, optionally into a mould which can later be released. Polyurethane foamable compositions which are applied by pouring and the resulting foams are often known as “pour-in-place” compositions or foams respectively.

While in-situ application is a useful technique, there are also challenges associated therewith. For example, the foamable composition must be able to be applied and then to react and cure in varied environments, for example outside while exposed to weather conditions. The foamable composition must also be suitable for use with a more limited range of dispensing equipment than is available when preparing foams in a factory.

Polyurethane foams are produced by reacting a polyisocyanate with a polyol in the presence of a blowing agent, a catalyst, a surfactant, and optionally other ingredients. Isocyanate index is used as a measure of the relative molar amounts of isocyanate and hydroxyl groups (and thus polyol) in a polyurethane foam, wherein an isocyanate index of 100 represents a roughly equimolar ratio of isocyanate to hydroxyl and an isocyanate index greater than 100 represents a molar excess of isocyanate. Polyurethane foams generally have an isocyanate index of around 100 or greater. Generally polyurethane foams with an isocyanate index greater than approximately 180 are referred to by the skilled person as polyisocyanurate (PIR) foams or PUR-PIR foams. The present invention relates to polyurethane foams having an isocyanate index up to 250, which would include materials which would be recognised by the skilled person as PIR or PUR-PIR foams.

Polyurethane foams are frequently made from polymeric methylene diphenyl diisocyanate (pMDI) components. pMDI components are readily commercially available and generally are blends of different MDI (methylene diphenyl diisocyanate) isomers. pMDI components often contain monomeric 4,4′-MDI (“pure MDI”) as well as oligomers containing 3-6 rings and other minor isomers, such as the 2,2′-isomer. pMDI components may also be referred to as prepolymers. It will be understood by the skilled person that pMDI components referred to herein may comprise methylene diphenyl diisocyanate monomers, oligomers, polymers, and isomers thereof, and combinations, mixtures and blends thereof.

Polymeric foams such as polyurethane foams may be formed by expanding a blowing agent, which generally has a low thermal conductivity, in a polymeric resin or prepolymeric reactants which will react to form a polymeric resin. The foam cells contain the blowing agent, whose low thermal conductivity imparts excellent insulating properties to the foam. The closed cell structure of the foam ensures these gases cannot escape from the product. Foams may be flexible or rigid depending on whether their glass transition temperature is below or above room temperature, which in turn depends on their chemical composition, the degree of crystallinity, and the degree of cross-linking in the polymeric matrix. The physical properties of the foam are greatly influenced by the properties of both the polymeric matrix, and any blowing agent retained within cells of the foam.

For most applications in which polyurethane insulation foams are employed, it is desirable to use an insulation foam having excellent fire performance, in particular reaction-to-fire performance, which is an indicator of the rate at which a fire spreads after a material is ignited by a heat source. Desirably, the insulation products should combine excellent thermal insulation performance with excellent fire performance.

The use of flame retardants as additives is a common way to improve fire performance. However, the use of flame retardants is not always preferred as in some cases flame retardants may have deleterious effects on the physical properties of the foam, for example lowering the foam's compressive strength. For example some flame retardants (FRs), in particular liquid flame retardants, may have a plasticising effect on final foam. This plasticising effect affects the foam's mechanical properties and can lower a foam's compressive strength, particularly at higher ambient temperature. The plasticising effect may also allow low thermal conductivity blowing agent within the foam cells to diffuse out of the foam cells, thus adversely affecting the thermal conductivity of the foam.

It therefore remains a challenge to make polyurethane insulation foams having excellent reaction-to-fire performance while maintaining excellent thermal insulation performance and without compromising the physical properties of the foam. The present invention aims to address these challenges.

### SUMMARY OF THE INVENTION

In one aspect, the present invention provides a foamable polyurethane composition comprising:
(a) at least one polyol component;
(b) a catalyst;
(c) a blowing agent;
(d) a surfactant;
(e) a polymeric methylene diphenyl diisocyanate (pMDI) component, wherein the pMDI component has a viscosity of greater than about 500 cPs when measured at 25° C. according to ASTM D4889.

The composition may further comprise water.

The pMDI component may have a viscosity of greater than about 600 cPs when measured at 25° C. according to ASTM D4889. The pMDI component may have a viscosity of greater than about 650 cPs when measured at 25° C. according to ASTM D4889. The pMDI component may have a viscosity of from about 650 cPs to about 750 cPs, for example approximately 700 cPs.

The pMDI component may have a functionality (f) of from about 2.7 to about 3.2, for example from about 2.8 to about 3.1, such as from about 2.85 to about 2.95.

The pMDI component may be present in an amount of from about 40% to about 60% based on the total weight of the composition, for example in an amount of from about 48% to about 60% based on the total weight of the composition, such as in an amount of from about 50% to about 56% based on the total weight of the composition.

This may equate to pMDI being present in the composition in a total amount of from about 40% to about 60% based on the total volume of the composition, for example in an amount of from about 45% to about 55% based on the total volume of the composition.

The at least one polyol component can be any polyol component comprising at least two reactive groups, preferably OH groups, especially polyether alcohols and/or polyester alcohols having OH numbers in the range from 150 to 800 mg KOH/g, for example 200 mg KOH/g to 400 mg KOH/g. It is preferable to use trimethylolpropane, glycerol, pentaerythritol, sugar compounds such as for example glucose, sorbitol, mannitol and sucrose, polyhydric phenols, resoles, for example oligomeric condensation products formed from phenol and formaldehyde and Mannich condensates formed from phenols, formaldehyde and dialkanolamines, and also melamine, or having at least two primary amino groups in the molecule, it is preferable to use aromatic di- and/or polyamines, for example phenylenediamines, and 4,4′-, 2,4′- and 2,2′ diaminodiphenylmethane and also aliphatic di- and polyamines, such as ethylenediamine.

The at least one polyol component may comprise one or more of the following: polyether polyols, polyester polyols, or combinations thereof. Suitable polyether polyols for use in the invention may be hydroxyl numbers in the range of from 150 mg KOH/g to 800 mg KOH/g, such as 200 mg KOH/g to 400 mg KOH/g. Suitable polyester polyols for use in the invention may be those having hydroxyl numbers in the range of from 150 mg KOH/g to 800 mg KOH/g, such as 200 mg KOH/g to 400 mg KOH/g.

The at least one polyol component may be a combination of two or more polyol compounds as co-polyols.

The at least one polyol component may be present in an amount of from about 25% to about 40% based on the total weight of the composition, for example in an amount of from about 30% to about 35% based on the total weight of the composition.

The catalyst may comprise one or more catalysts taken from the following categories: blowing catalysts, trimerization catalysts, gelling catalysts, and combinations thereof. Suitable catalysts for isocyanate cyclotrimerisation are disclosed in Table 6.3 of Klempner “Polymeric Foams and Foam Technology” 2^{nd} Edition and could also include those disclosed in EP3310827A1. Catalysts used are particularly compounds that have a substantial effect on the rate of reaction of isocyanate groups with isocyanate-reactive groups. Examples of such catalysts are amines, such as tertiary aliphatic amines, and organometallic compounds including potassium catalysts. The catalysts can be used alone or in any desired mixtures with each or one another, as required.

The catalyst may be present in an amount of from about 0.030% to about 0.800 based on the total weight of the composition, such as in an amount of from about 0.050% to about 0.500%, for example from about 0.100% to about 0.400% based on the total weight of the composition.

The catalyst may comprise one or more amine catalysts. The one or more amine catalysts may be present in an amount of from about 0.030% to about 0.040% based on the total weight of the composition.

The catalyst may comprise one or more potassium catalysts. The one or more potassium catalysts may be present in an amount of from about 0.030% to about 0.040% based on the total weight of the composition.

The blowing agent may comprise water. Suitably the blowing agent may comprise water as a co-blowing agent in combination with one or more organic blowing agents.

The blowing agent may comprise a halogenated hydroolefin, for example a halogenated hydroolefin selected from the group consisting of hydrofluoroolefins and hydrochlorofluoroolefins. Halogenated hydroolefins are advantageous as blowing agents as they have low global warming potential as well as providing excellent thermal insulation properties. The blowing agent may comprise one or more halogenated hydroolefins selected from the group comprising: 1-chloro-3,3,3-trifluoropropene, 1-chloro-2,3,3,3-tetrafluoro-1-propene, 1,3,3,3-tetrafluoro-1-propene, 2,3,3,3-tetrafluoro-1-propene, 1,1,1,4,4,4-hexafluoro-2-butene, 1,1,1,3,3-pentafluoro-2-propene, and combinations thereof.

The blowing agent may additionally or alternatively comprise a C₃-C₇ hydrocarbon selected from the group consisting of propane, butane, pentane, hexane, heptane, and isomers thereof, including combinations thereof. Such compounds are advantageous as blowing agents as they have low thermal conductivity, may be used to form closed cell foams having stable excellent thermal insulation performance, and have low environmental impact.

The blowing agent may additionally or alternatively comprise a C₂-C₅ halogenated hydrocarbon, for example, the blowing agent may comprise a chlorinated aliphatic hydrocarbon, for example the blowing agent may comprise a chlorinated aliphatic unsaturated hydrocarbon such as one of the following: dichloroethane, 1,2-dichloroethylene, n-propyl chloride, isopropyl chloride, butyl chloride, isobutyl chloride, pentyl chloride, isopentyl chloride, 1,1-dichloroethylene, trichloroethylene, or chloroethylene.

Suitably the blowing agent is present in an amount of from about 1% to about 15% based on the total weight of the composition, for example in an amount of from about 1% to about 10% based on the total weight of the composition.

Suitably, the blowing agent has low thermal conductivity. The foam will comprise cells in which the blowing agent is trapped. As the gas volume of a foam may account for up to about 95% of the volume of a foam, the amount and nature of the blowing agent trapped in the foam has a significant impact on the thermal insulating performance of the foam. In order to form thermal insulating foam, a total closed cell content of 85 percent or more is generally required, as one of the main determinants in the thermal insulation performance of foam is the ability of the cells of the foam to retain blowing agent having a low thermal conductivity.

The surfactant (i.e. a surface-active substance) acts to stabilize the cells and to keep their size as low as possible as they are formed by reaction of the composition. The function of the surfactant is to retain blowing agent within the cells. The surfactant may comprise a silicone-based surfactant, for example a polyether-polysiloxane copolymer. Alternatively or additionally, the surfactant may comprise a silicone-free surfactant.

The surfactant may be present in an amount of from about 0.1% to about 5% based on the total weight of the composition, preferably in an amount of from about 0.5% to about 2% based on the total weight of the composition.

The composition may further comprise one or more additives selected from the group comprising: fillers, pigments, dyes, antioxidants, flame retardants, plasticisers, toughening agents, hydrolysis control agents, antistats, fungistats and bacteriostats.

Suitably, the composition comprises a flame retardant. Suitable flame retardants include those selected from the group comprising: organophosphates; organophosphonates, organochlorines, organobromines, and combinations thereof. The flame retardant could be a phosphate ester. The flame retardant could be reactive or unreactive or could be a combination of reactive and unreactive flame retardants.

The flame retardant may be present in an amount of from about 1% to about 30% based on the total volume of the composition, preferably in an amount of from about 2% to about 25% based on the total volume of the composition.

The composition may comprise a first part and a second part, wherein the at least one polyol component, the catalyst, and the surfactant are present in the first part and the pMDI component is present in the second part.

Advantageously this means that the two parts of the composition can be prepared in advance and then stored until required. When prepared as described both the first part and the second part are each stable and have a long shelf life, allowing them to be transported and stored for on-site uses as required. No reaction will take place until the second part, comprising the pMDI component, is combined with the first part, at which point the components will begin to react and form a foam.

Suitably the pMDI component is present in the second part and all other components are present in the first part.

The first and second part may be present in the foamable polyurethane composition in a relative ratio of from about 1:2 to about 2:1 by volume, for example from about 1:1.2 to about 1.2:1 by volume. The first and second part may be present in the foamable polyurethane composition in a relative ratio of from about 1:1.05 to about 1.05:1 by volume.

Suitably upon combination of the first part and the second part, the composition reacts to form a foam with a creaming time of from about 20 seconds to about 100 seconds when measured according to ASTM D7487-18 and/or a gel time of from about 20 seconds to about 400 seconds when measured according to ASTM D7487-18.

The composition of the present invention is able to react and cure to form a polyurethane insulation foam having cells in which blowing agent is trapped.

Desirably, the composition of the present invention is able to react and cure to form a polyurethane insulation foam across a wide temperature range, for example from 0° C. to 55° C. Such compositions are useful for on-site application of foams carried out externally, i.e. while the foam and/or the parts to be insulated are exposed to various weather conditions.

The present invention also relates to a polyurethane foam made by foaming and curing a composition according to the invention. The polyurethane foam is a cured foam product made by foaming and curing a composition according to the invention.

This may be a moulded polyurethane foam prepared by dispensing a composition of the invention into a mould then allowing the composition to foam and cure. The mould can then be removed from the polyurethane foam.

The polyurethane foam is suitable for use as a thermal insulation foam.

The polyurethane foam is a rigid polyurethane foam.

The polyurethane foam may have a closed cell content of greater than 60% when measured according to ASTM D6226. Desirably the polyurethane foam may have a closed cell content of greater than 95% measured according to ASTM D6226. This is beneficial as it allows for retention of the blowing agent which allows for low thermal conductivity.

The polyurethane foam may have a thermal conductivity of from 0.10 BTU (0.17 W/m·K to 0.50 BTU (0.86 W/m·K), for example a thermal conductivity of 0.2 BTU (0.35 W/m·K) or less, when measured at 75° F. (23.89° C.) according to ASTM C₁₇₇.

The polyurethane foam may have a compressive strength of from about 12 psi (83 kPa) to about 60 psi (414 kPa), for example a compressive strength of greater than 25 psi (172 kPa) or greater than 29 psi (200 kPa) when measured according to ASTM D1621. A high compressive strength means that the foam is resistant to compressive damage.

The polyurethane foam may have a density in the range of from about 20 kg/m³ to about 80 kg/m³, such as from about 30 kg/m³ to about 60 kg/m³, for example from about 40 kg/m³ to about 50 kg/m³, when measured according to ASTM D1622.

Beneficially polyurethane foams according to the present invention display excellent reaction-to-fire performance.

The polyurethane foam may achieve a flame spread index (FSI) of no greater than about 75, preferably no greater than about 50, and particularly preferably of no greater than about 25, when measured according to ASTM E84.

The polyurethane foam may achieve a smoke-developed index (SDI) of no greater than about 800, preferably no greater than about 600, and particularly preferably of no greater than about 450, when measured according to ASTM E84.

The polyurethane foam may achieve a lower flame spread index (FSI) and/or a lower smoke-developed index (SDI), measured according to ASTM E84, than an equivalent foam prepared with a pMDI component having a viscosity of less than about 500 cPs when measured at 25° C. according to ASTM D4889

The polyurethane foam may be assigned Class 1 or A or Class 2 or B according to the ASTM E84 acceptance criteria. Preferably the polyurethane foam may be assigned Class 1 or A according to the ASTM E84 acceptance criteria.

Without wishing to be bound by theory, it is believed that the high viscosity of the pMDI component used in the present invention may impart improved fire resistance compared to conventional pMDIs. This may be, for example, because of an increased aromatic content.

The present invention also relates to a method of producing a polyurethane foam comprising curing a composition of the present invention.

Polyurethane foams made according to the method of the invention are suitable for use as thermal insulation foams.

The present invention also relates to a method of producing a polyurethane foam comprising the steps of:
(a) providing a first part comprising:
   i. at least one polyol component;
   ii. a catalyst;
   iii. a blowing agent;
   iv. a surfactant;
(b) providing a second part comprising a polymeric methylene diphenyl diisocyanate (pMDI) component, wherein the pMDI component has a viscosity of greater than about 500 cPs when measured at 25° C. according to ASTM D4889;
(c) combining the first part and the second part to form a foamable polyurethane composition;
(d) allowing the foamable polyurethane composition to react and cure.

It will be understood that compositions according to the invention are suitable for use in methods according to the invention. Similarly, methods according to the invention are suitable for use with compositions according to the invention.

Compositions and methods according to the invention are also suitable for producing polyurethane foams and/or cured foam products and/or assemblies according to the invention.

The first part and/or the second part may further comprise water.

The first part and second part once combined may constitute a composition according to the present invention.

Step (c) may comprise combining the first part and the second part to form a foamable polyurethane composition according to the present invention.

Suitably, the first part and the second part are combined in a ratio of from about 1:2 to about 2:1 by volume, such as from about 1:1.2 to about 1.2:1 by volume.

The present invention also relates to a polyurethane foam made according to a method of the invention.

Methods of the invention are particularly suitable for use in field applications. The two parts of the composition can be prepared in advance and then stored until required. When prepared as described both the first part and the second part are each stable and have a long shelf life, allowing them to be transported and stored for on-site uses as required. No reaction will take place until the second part, comprising the pMDI component, is combined with the first part, at which point the components will begin to react and form a foam.

The first part and second part can be combined in a number of ways. This may depend on the intended application of the polyurethane foam. For example, the first part and the second part may be provided in separate containers, such as drums. These may be dispensing containers. The first part and the second part may then be dispensed simultaneously from the containers and allowed to combine. Or one part may be dispensed first, followed by the other part being dispensed and the two parts allowed to combine. The first part and the second part may be provided in separate containers and then each dispensed through separate pipes or nozzles. Or the first and the second part may be provided in separate containers, combined in a mixing chamber and then dispensed as a foamable polyurethane composition.

The foamable polyurethane composition may be applied directly to a substrate, for example a part to be insulated. In this regard the method of the invention may further comprise the step, between steps (c) and (d), of applying the foamable polyurethane composition to a substrate. Advantageously the composition will then react and cure around or against the substrate leading to a perfect fit. Similarly, compositions according to the invention are suitable for application directly to a substrate.

The foamable polyurethane composition may be applied to a substrate by spraying or pouring. The foamable polyurethane composition may be applied to a substrate by dispensing into a mould placed around or near the substrate, for example by spraying or pouring into a mould placed around or near the substrate.

The present invention also relates to a method of applying a composition according to the invention to a substrate, comprising the steps of:
(a) providing a foamable polyurethane composition according to the invention;
(b) applying the foamable polyurethane composition to a substrate;
(c) allowing the foamable polyurethane composition to react and cure.

The present invention also relates to an assembly comprising a substrate and a polyurethane foam wherein the polyurethane foam is applied to the substrate, optionally wherein the polyurethane foam is moulded to the substrate.

The present invention also relates to compositions, methods, polyurethane foams, and assemblies as defined by the claims or clauses herein.

### DETAILED DESCRIPTION

Suitable testing methods for measuring the physical properties of polyurethane foam are described below.

Foam density was measured according to ASTM D1622.

Flame spread index (FSI) was measured according to ASTM E84.

Smoke-developed index (SDI) was measured according to ASTM E84.

Foamable polyurethane compositions according to the invention (Examples 1 and 2) were prepared and allowed to react and cure to form polyurethane insulation foams. The components used and their relative weights (shown in comparison to 100 parts per weight pMDI) are shown in Table 1. The polyols, flame retardant, surfactant(s), catalysts, blowing agent, and water were combined in one drum (Part B). Mondur® 489 was provided in a separate drum (Part A). Mondur® 489 (Covestro AG) is a polymeric MDI having a viscosity of approximately 700 mPa·s. Part A and Part B were combined in a 1:1 volume ratio. The resulting composition was allowed to react and cure.

Comparative Examples 1 and 2 were prepared in the same manner as Examples 1 and 2, the only difference being that Mondur® MR-LT was used as the pMDI. Mondur® MR-LT (Covestro AG) is a polymeric MDI having a viscosity of approximately 200 mPa·s.

TABLE 1

| | | | | Compar- | Compar- |
|---|---|---|---|---|---|
| | | | | ative | ative |
| | | Exam- | Exam- | Exam- | Exam- |
| | | ple 1 | ple 2 | ple 1 | ple 2 |
| B-side | Polyester polyol | 35.00 | 30.00 | 35.00 | 30.00 |
| compo- | Polyether polyol | 38.80 | 44.10 | 38.80 | 44.10 |
| nents | Flame retardant | 10.00 | 8.00 | 10.00 | 8.00 |
| | Surfactant 1 | 1.60 | 1.00 | 1.60 | 1.00 |
| | Surfactant 2 | — | 2.00 | — | 2.00 |
| | Catalyst 1 | 0.30 | — | 0.30 | — |
| | Catalyst 2 | 0.30 | — | 0.30 | — |
| | Catalyst 3 | 0.25 | — | 0.25 | — |
| | Catalyst 4 | — | 0.70 | — | 0.70 |
| | Catalyst 5 | — | 0.20 | — | 0.20 |
| | Water | 0.80 | 0.30 | 0.80 | 0.30 |
| | Blowing Agent | 13.00 | 13.00 | 13.00 | 13.00 |
| A-side | Mondur ® MR-LT | — | — | 100 | 100 |
| compo- | Mondur ® 489 | 100 | 100 | — | — |
| nents | | | | | |

The foams' densities were measured and are shown in Table 2. Also shown in Table 2 are the results of a mass loss test. Foam samples were cut to a standard size and the initial unburned weight measured. The samples were then burned for a set time interval, reweighed, and the wt % lost calculated. The amount of weight lost during burning is a measure of fire performance, wherein loss of a lower amount of mass corresponds to improved fire resistance.

TABLE 2

| | | | Compar- | Compar- |
|---|---|---|---|---|
| | | | ative | ative |
| | Exam- | Exam- | Exam- | Exam- |
| | ple 1 | ple 2 | ple 1 | ple 2 |
| Density/kg/m³ | 42.61 | 47.17 | 42.85 | 45.89 |
| % wt lost in mass lost test | 49.8 | 54.8 | 59.9 | 63.9 |

The foams' reaction-to-fire performance was measured according to ASTM E84. Flame spread index (FSI) and smoke-developed index (SDI) results are shown in Table 3.

TABLE 3

| | | | Compar- | Compar- |
|---|---|---|---|---|
| | | | ative | ative |
| | Exam- | Exam- | Exam- | Exam- |
| | ple 1 | ple 2 | ple 1 | ple 2 |
| Flame spread index (FSI) | 62 | 60 | 95 | 327 |
| Smoke-developed index | 650 | 777 | 750 | 793 |

For reaction-to-fire tests done according to ASTM E84, a lower value is considered a better result. From the results in Table 2 it can be seen that the inventive foams performed considerably better in flame spread index testing than the equivalent comparative foams prepared with a conventional low-viscosity pMDI. The inventive foams also outperformed the comparative foams in smoke-developed index testing.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A foamable polyurethane composition comprising:
(a) at least one polyol component;
(b) a catalyst;
(c) a blowing agent;
(d) a surfactant;
(e) a polymeric methylene diphenyl diisocyanate (pMDI) component, wherein the pMDI component has a viscosity of greater than about 500 cPs when measured at 25° C. according to ASTM D4889.

2. The composition of claim 1, wherein the pMDI component has a functionality (f) of from about 2.7 to about 3.2.

3. The composition of claim 1, wherein the at least one polyol component comprises one or more of the following: polyether polyols, polyester polyols, or combinations thereof.

4. The composition of claim 1, wherein the catalyst comprises one or more catalysts taken from the following categories: blowing catalysts, trimerization catalysts, gelling catalysts, and combinations thereof.

5. The composition of claim 1, wherein the blowing agent comprises a halogenated hydroolefin selected from the group consisting of hydrofluoroolefins and hydrochlorofluoroolefins.

6. The composition of claim 1, further comprising water.

7. The composition of claim 1, further comprising at least one surfactant, such as a silicone-based surfactant.

8. The composition of claim 1, further comprising one or more additives selected from the group comprising: fillers, pigments, dyes, antioxidants, flame retardants, plasticisers, toughening agents, hydrolysis control agents, antistats, fungistats and bacteriostats.

9. The composition of claim 1, wherein the composition comprises a first part and a second part and wherein the at least one polyol component, the catalyst, and Substitute Specification-Marked-Up Copy the surfactant are present in the first part and the pMDI component is present in the second part.

10. The composition of claim 9, wherein the first part and the second part are present in the foamable polyurethane composition in a relative ratio of from about 1:1.2 to about 1.2:1 by volume.

11. A polyurethane foam made by foaming and curing a composition according to claim 1.

12. The polyurethane foam according to claim 11, having a density in the range of from about 20 kg/m³ to about 80 kg/m³, such as from about 30 kg/m³ to about 60 kg/m³, for example from about 40 kg/m³ to about 50 kg/m³, when measured according to ASTM D1622.

13. The polyurethane foam according to claim 11, wherein the polyurethane foam achieves a flame spread index (FSI) of no greater than about 75, when measured according to ASTM E84.

14. The polyurethane foam according to claim 11, wherein the polyurethane foam achieves a smoke-developed index (SDI) of no greater than about 800, when measured according to ASTM E84.

15. A method of producing a polyurethane foam comprising curing a composition according to claim 1.

16. A method of producing a polyurethane foam comprising
(a) providing a first part comprising:
i. at least one polyol component;
ii. a catalyst;
iii. a blowing agent;
iv. a surfactant;
(b) providing a second part comprising a polymeric methylene diphenyl diisocyanate (pMDI) component, wherein the pMDI component has a viscosity of greater than about 500 cPs when measured at 25° C. according to ASTM D4889;
(c) combining the first part and the second part to form a foamable composition;
(d) allowing the foamable composition to react and cure.

17. The method of claim 16, wherein the first part and the second part are combined in a ratio of from about 1:2 to about 2:1 by volume, such as from about 1:1.2 to about 1.2:1 by volume.

18. A polyurethane foam made according to the method of claim 16.

19. A method of applying a polyurethane foam to a substrate, comprising the steps of:
(a) providing a foamable polyurethane composition according to claim 1;
(b) applying the foamable polyurethane composition to a substrate;
(c) allowing the foamable polyurethane composition to react and cure.

20. An assembly comprising a substrate and a polyurethane foam according to claim 18, wherein the polyurethane foam is applied to the substrate.
